(19) United States
(12) Patent Application Publication
(10) Pub. No.: US 2017/0169499 A1
(43) Pub. Date: Jun. 15, 2017

(54) SYSTEM FOR PROVIDING A PRODUCT RECOMMENDATION BASED ON COLOR

(71) Applicant: REVLON CONSUMER PRODUCTS CORPORATION, New York, NY (US)

(72) Inventor: Parth MEHROTRA, Wayne, NJ (US)

(21) Appl. No.: 15/116,108

(22) PCT Filed: Jan. 26, 2015
(86) PCT No.: PCT/US15/12852

§ 371 Date: Aug. 2, 2016

Related U.S. Application Data
(60) Provisional application No. 61/935,123, filed on Feb. 3, 2014.

(51) Int. Cl. G06Q 30/06; G01J 3/46; G06K 9/52; G06K 9/46; G06K 9/62

(52) U.S. Cl. CPC G06Q 30/0631; G06Q 30/0643; G06Q 30/0621; G06K 9/4652; G06K 9/4671; G06K 9/6215; G06K 9/52; G06K 9/6267; G01J 3/463; G06K 2209/19; G01J 2003/467

(57) ABSTRACT

A system for providing a product recommendation based on color includes a computer processor and a memory device. The memory device stores at least one piece of computer code executable by the computers processor and data used by the computer code. The computer code includes a determination module, an identification module, and a presentation module. The determination module determines a color of interest from one pixel. The identification module identifies a product from a predetermined list of products based on the color of interest. The presentation module presents an identifier of the product via a user interface.

### BACKGROUND

Field of the Invention

The present application relates to a system for providing a product recommendation. More particularly, example aspects herein relate to systems, methods, and computer program products for providing a product recommendation based on a color, such as a color that is provided and/or selected by a user.

Description of Related Art

Nowadays, in choosing a product for purchase, consumers are presented with a seemingly endless amount of choices. The growth in electronic commerce has made the amount of choices seem even more vast, since, with minimal effort, consumers may browse entire inventories of product offerings by simply navigating through a website or a mobile application provided via a computer or mobile communication device.

In order to make the task of choosing a product more manageable, consumers often narrow down choices based on some criterion. One example of such a criterion is color, which can be useful in identifying certain products of interest, such as, for example, cosmetics. In some cases, for instance, a consumer may come across a color that the consumer finds to be appealing, for example, in an object that they encounter, in a magazine photograph, and/or the like. The consumer may wish to identify, and/or receive recommendations of, cosmetics having a similar color. To date, however, consumers have lacked a convenient means of doing so.

Given the foregoing, it would be beneficial to have a means of providing consumers with product recommendations based on color, and enable the users to obtain and browse the product recommendations via a convenient and user-friendly interface.

### SUMMARY

The example embodiments herein provide systems, methods, and computer program products for providing a product recommendation based on color. In accordance with one example aspect herein, a system includes a computer processor and a memory device. The memory device stores at least one piece of computer code executable by the computers processor and data used by the computer code. The computer code includes a determination module, an identification module, and a presentation module. The determination module determines a color of interest from one pixel. The identification module identifies a product from a predetermined list of products based on the color of interest. The presentation module presents an identifier of the product via a user interface.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments presented herein will become more apparent from the detailed description set forth below when taken in conjunction with the drawings, in which

FIG. 1 shows an example arrangement of various components of a system for providing a product recommendation based on a color, according to various example embodiments herein;

FIG. 2 is a block diagram of a computer for use with various example embodiments herein;

FIG. 3 illustrates exemplary functional modules that may be included in a memory device and used for providing a product recommendation based on a color, according to various example embodiments herein;

FIG. 4 is a flowchart illustrating an example procedure for providing a product recommendation based on a color, according to various example embodiments herein;

FIG. 5 shows an example interface for selecting an image, according to various example embodiments herein;

FIG. 6 shows an example interface for selecting a pixel of an image, according to various example embodiments herein;

FIG. 7 shows an example interface for adjusting a color of interest, according to various example embodiments herein;

FIG. 8 shows an example interface for presenting identifiers of recommended products, according to various example embodiments herein;

FIG. 9 shows an example interface for storing identifiers of recommended products for future reference, according to various example embodiments herein;

FIG. 10 is a flowchart illustrating an example procedure for determining a color of interest from a selected pixel, according to various example embodiments herein; and

FIG. 11 is a flowchart illustrating an example procedure for identifying, from a predetermined list of products, one or more product(s) for recommendation based on a color of interest, according to various example embodiments herein.

### DETAILED DESCRIPTION

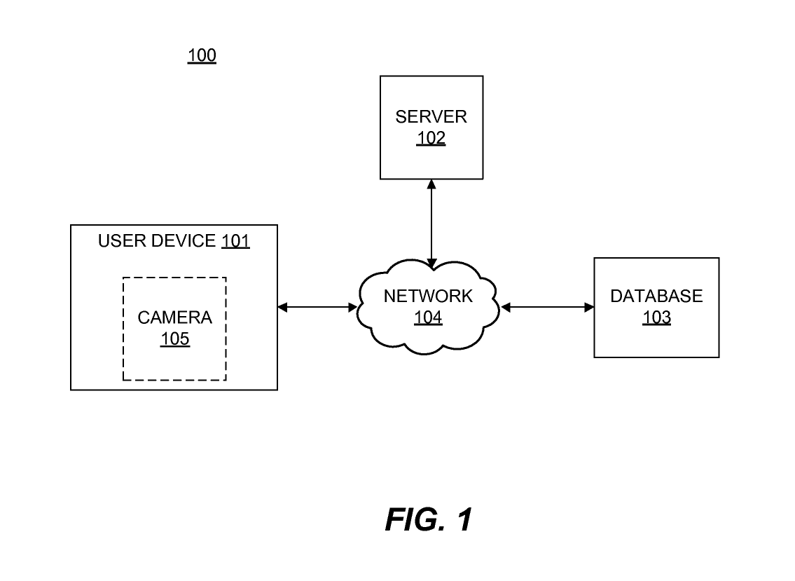

FIG. 1 shows an example arrangement of various components of a system 100 for providing a product recommendation based on a color, according to an example embodiment herein. The system includes a user device 101, a server 102, and a database 103 that are mutually coupled by way of a communication network 104 that enables data to be communicated therebetween. In some example embodiments, the communication network 104 may be a publicly accessible network, such as the Internet.

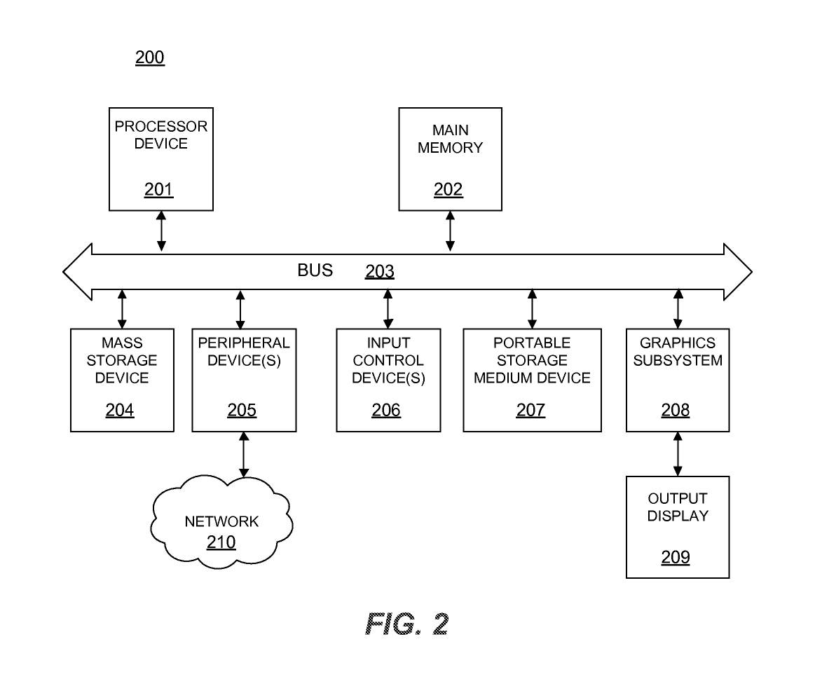

The user device 101 may be a general and/or special purpose computer (e.g., the computer system 200 described below in connection with FIG. 2), a mobile communication device (e.g., a smartphone), a laptop computer, a desktop computer, a tablet computer, and/or any other user device suitable for a user to input information used to provide a product recommendation based on color, and for providing such a product recommendation, in accordance with the example embodiments herein. In one example embodiment, the user device 101 includes an optional camera 105, which, as described in further detail below, may be used to capture an image to be used as the basis for a product recommendation.

The server 102 may be a general and/or special purpose computer (e.g., computer system 200 described below). The software executed by the user device 101 may be Web-based software (e.g., software hosted by the server 102), for easy access by any user, local software hosted by the user device 101, and/or a combination of Web-based software and local software.

The database 103 stores data that is utilized by the server 102 in providing a product recommendation based on color, in accordance with the example embodiments herein. For example, the database 103 may store one or more predetermined lists of products (e.g., cosmetics products), including product information for each product, such as, for example, (1) a corresponding product identifier (e.g., an identifier that uniquely identifies the product), (2) a category (e.g., nails, eyes, lips, face) to which the product belongs, (3) one or more corresponding color identifiers that identify one or more colors of the product (e.g., with the color identifiers being represented based on a color space, such as a red, green, and blue (RGB) color space, a Lab color space, and/or another color space), (4) a name of the product, (5) a name of a color of the product, (6) a pre-stored image of the product, and/or (7) other product information.

In one example embodiment, the database 103 is a static database that stores a plurality of data entries corresponding to a plurality of products, respectively, each of the products being associated with a corresponding color or shade. Each of the data entries, in one example, includes a set of data elements, such as the data elements shown below in Table 1.

TABLE 1

| Data Element | Description |
|---|---|
| Shade Name | Name of shade (textual field) |
| R value | Numerical value (e.g., integer ranging from |
| | 0-255) corresponding to the red color |
| | component of the shade |
| G value | Numerical value (e.g., integer ranging from |
| | 0-255) corresponding to the green color |
| | component of the shade |
| B value | Numerical value (e.g., integer ranging from |
| | 0-255) corresponding to the blue color |
| | component of the shade |
| Image File | An image of the shade (e.g., .PNG file) |

Table 2 shows example data entries that may be stored in the database 103.

TABLE 2

| Name | R Value | G Value | B Value | Image File Name |
|---|---|---|---|---|
| ALL ABOUT YOU | 148 | 96 | 25 | allaboutyou.png |
| AMETHYST | 123 | 69 | 117 | amethyst.png |

As shown in Table 1 above, each data entry (having a corresponding shade) includes (1) a shade name data element, which is a textual field representing a name associated with the shade; (2) R value, G value, and B value data elements, which are numerical values (e.g., integers ranging from 0-255) corresponding to the red, green, and blue color components, respectively, of the shade; and (3) an image file data element, which includes a file name, a pointer, or a link corresponding to an image file (e.g., a .PNG file) including an image depicting the shade. In one example embodiment, instead of, or in addition to, the R, G, and B values mentioned above, L, a, and b values may be stored in each data entry.

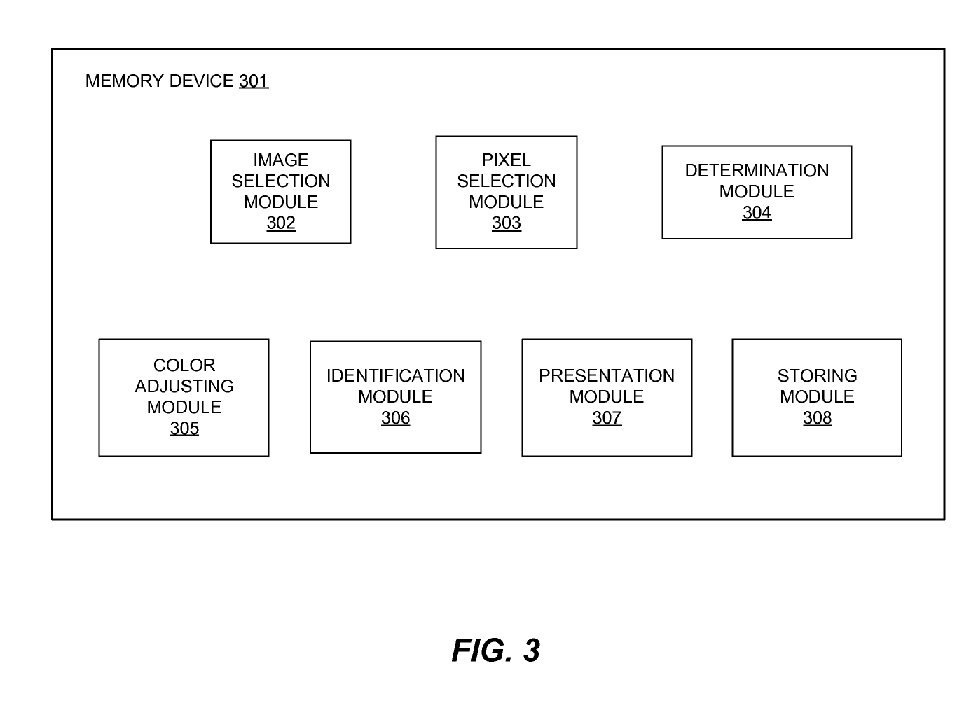

In accordance with another example aspect herein, the image associated with the image file data element can be presented (e.g., as described below in connection with the presentation module 307) to the user, via a user interface, to illustrate the characteristics of the shade, which may be homogenous or non-homogenous (e.g., a shade of a cosmetic product that includes glitter particles). In one example, for a shade that is non-homogenous, and thus includes more than one color, a single set of R, G, and B values (e.g., R, G, and B values that correspond to a predominant color included in the shade) may be stored for the shade, and used to identify (e.g., as discussed below in connection with the identification module 306 of FIG. 3) one or more products from a predetermined list of products based on a color of interest.

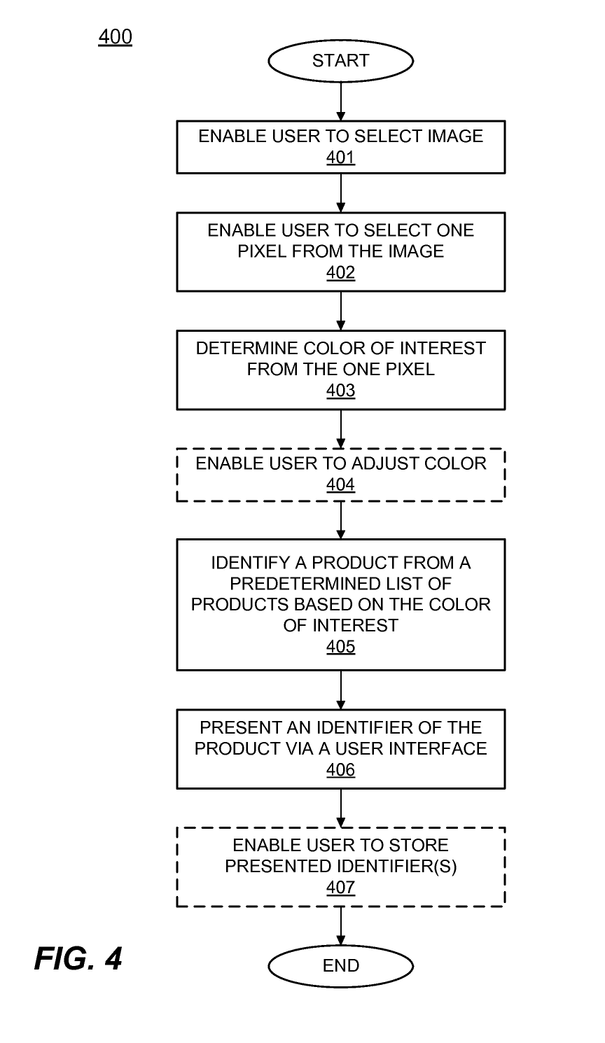

In general, and as will be described in more detail below in the context of FIGS. 3 and 4, the user device 101 executes software that enables a user (e.g., a consumer) to: (1) select a digital image (e.g., from a plurality of preselected images or from a photographic image captured via a camera (e.g., the camera 105) resident on a mobile device); (2) select a pixel from a plurality of pixels of the selected image; and (3) provide information to the server 102 to cause the server 102 to: (a) determine a color of interest from the selected pixel; (b) identify for recommendation, based on the determined color of interest, one or more products from a predetermined list of products stored in the database 103; and (c) present one or more identifiers (e.g., recommendations) of the one or more identified products via a user interface.

In some example embodiments, the functionality provided by the server 102 and the database 103 is incorporated into the user device 101 itself, such as by an app downloaded to and resident in memory (not shown in FIG. 1) of the user device 101, so that the user device 101 may be utilized in a standalone manner to implement the features described herein without any connectivity to the network 104. As will be appreciated by persons skilled in the art, an app downloaded to the user device 101 can be periodically updated by techniques known in the art. In these example embodiments, an internal processor (not shown in FIG. 1) of the user device 101 functions to run the app resident in the memory.

Having described a system 100 for providing a product recommendation based on a color, according to an example embodiment herein, reference will now be made to FIG. 2, which shows a block diagram of a general and/or special purpose computer system 200 that may be employed in accordance with some of the example embodiments herein. The computer system 200 may be, for example, a user device, a user computer, a client computer, and/or a server computer, among other things. In some example embodiments herein, the computer system 200 may further represent the user device 101, the server 102, and/or the database 103 described above in connection with FIG. 1.

The computer system 200 may include, without limitation, a computer processor 201, a main memory 202, and an interconnect bus 203. The computer processor 201 may include, without limitation, a single microprocessor or alternatively a plurality of microprocessors for configuring the computer system 200 as a multi-processor system. The main memory 202 stores, among other things, instructions and/or data for execution by the processor device 201. The main memory 202 may include banks of dynamic random access memory (DRAM), as well as cache memory.

The computer system 200 may further include computer-readable mass storage device(s) 204, peripheral device(s) 205, input control device(s) 206, portable storage medium device(s) 207, graphics subsystem(s) 208, and/or one or more output display(s) 209. For explanatory purposes, all components in the computer system 200 are shown in FIG. 2 as being coupled via the bus 203. However, the computer system 200 is not so limited. Devices of the computer system 200 may be coupled via one or more data-transport devices known in the art. For example, the computer processor 201 and/or the main memory 202 may be coupled via a local microprocessor bus. The mass storage device(s) 204, the peripheral device(s) 205, the portable storage medium device(s) 207, and/or the graphics subsystem(s) 208 may be coupled via one or more input/output (I/O) buses. The mass storage device(s) 204 may be nonvolatile storage device(s) for storing data and/or instructions for use by the computer processor 201. The mass storage device(s) 204 may be implemented, for example, with one or more magnetic disk drive(s), solid state disk drive(s), and/or optical disk drive(s). In a software-related embodiment, at least one mass storage device 204, for example, a flash memory, is configured for loading contents of the mass storage device 204 into the main memory 202.

Each portable storage medium device 207 operates in conjunction with a nonvolatile portable storage medium, such as, for example, a compact disc with a read-only memory (CD-ROM) or a non-volatile storage chip (Flash), to input and output data and code to and from the computer system 200. In some embodiments, the software for storing an internal identifier in metadata may be stored on a portable storage medium, and may be inputted into the computer system 200 via the portable storage medium device 207. The peripheral device(s) 205 may include any type of computer support device, such as, for example, an input/output (I/O) interface configured to add additional functionality to the computer system 200. For example, the peripheral device(s) 205 may include a network interface card for interfacing the computer system 200 with a network 210.

The input control device(s) 206 provide among other things, a portion of the user interface for a user of the computer system 200. The input control device(s) 206 may include a keypad, a cursor control device, a touch sensitive surface coupled with the output display(s) 209 or standalone, a camera, a microphone, infrared sensors, knobs, buttons, and the like. The keypad may be configured for inputting alphanumeric characters and/or other key information. The cursor control device may include, for example, a mouse, a trackball, a stylus, and/or cursor direction keys. In order to display textual and graphical information, the computer system 200 may utilize the graphics subsystem(s) 208 and the output display(s) 209. The output display(s) 209 may include a cathode ray tube (CRT) display, a liquid crystal display (LCD), a projector device, and the like. Each graphics subsystem 208 receives textual and graphical information, and processes the information for output to at least one of the output display(s) 209.

Each component of the computer system 200 may represent a broad category of a computer component of a general and/or special purpose computer. Components of the computer system 200 are not limited to the specific implementations provided here.

Portions of the example embodiments of the invention may be conveniently implemented by using a conventional general purpose computer, a specialized digital computer, and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein, which can be used to control, or cause, a computer to perform any of the procedures of the example embodiments of the invention. The storage medium may include without limitation a floppy disk, a mini disk, an optical disc, a Blu-ray Disc™, a DVD, a CD-ROM, a micro drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer-readable medium or media, some implementations include software for controlling both the hardware of the general and/or special computer or microprocessor, and for enabling the computer or microprocessor to interact with a human user or other mechanism utilizing the results of the example embodiments of the invention. Such software may include, without limitation, device drivers, operating systems, and user applications. Additionally, such computer readable media further includes software for performing example aspects of the invention, as described herein.

Included in the programming and/or software of the general and/or special purpose computer or microprocessor are software modules for implementing the procedures described herein.

Having described a general and/or special purpose computer 200 that may be employed in accordance with some of the example embodiments herein, reference will now be made to FIG. 3, which illustrates exemplary functional modules that may be included in a memory device 301, in accordance with example embodiments herein. In some example embodiments, the memory device 301 is included in the computer system 200 described above in the context of FIG. 2, further represents the main memory 202 in part or in whole, and is used for providing a product recommendation based on a color. For example, although not shown in FIG. 3 for purposes of convenience, the memory device 301 is coupled to a computer processor (e.g., the computer processor 201) that, in turn, is coupled to one or more displays (e.g., the output display(s) 209) and optionally to one or more capabilities to exchange data over a network (e.g., the network 210). In one example embodiment, each display device 209 is structured to display a graphical interface (e.g., a GUI) to a user based on computer code (e.g., modules 302 through 308) executed by the computer processor 201. An input device (e.g., the input control device 206) is structured to receive information from the user via the user device 101. In some example embodiments herein, one or more of the modules 302 through 308 may be used to implement one or more of the functions associated with one or more of blocks 401 through 407, which are described in further detail below in the context of FIG. 4.

As shown in FIG. 3, the modules stored within the memory device 301 include an image selection module 302, a pixel selection module 303, a determination module 304, a color adjusting module 305, an identification module 306, a presentation module 307, and a storing module 308. As will be described in further detail below, each of the modules 302 through 308 includes computer-executable code that imparts functionality to the computer system 200 when executed by the computer processor 201 as well as data related to that code. Additionally, the memory device 301 stores computer programs and data for applications (e.g., an application resident on a mobile device running a mobile operating system, such as Android®, which is provided by Google®, iOS®, which is provided by Apple®, or another mobile operating system) that a user may interact with via one or more input devices 206.

In one example embodiment herein, the image selection module 302 enables the user to select an image from a plurality of preselected images (e.g., images pre-stored on the user device 101, the server 102, and/or the database 103). In another example, the image selection module 302 enables the user to select the image from a photographic image captured via a camera, such as a camera (e.g., the camera 105) resident on a mobile device (e.g., the user device 101). The image may be an image of an object, a photographic image, and/or another type of image.

The pixel selection module 303 enables the user to select a pixel from a plurality of pixels of the selected image. In one example, the pixel selection module 303 enables the user to select the pixel of the image, which is presented via a display, by pointing to the pixel with a cursor or pointing device, such as a mouse, or with a finger or stylus on a touchscreen display. For ease of selection of the desired pixel, the image may be enlarged on the display to enable the cursor or pointing device to more precisely select the desired pixel.

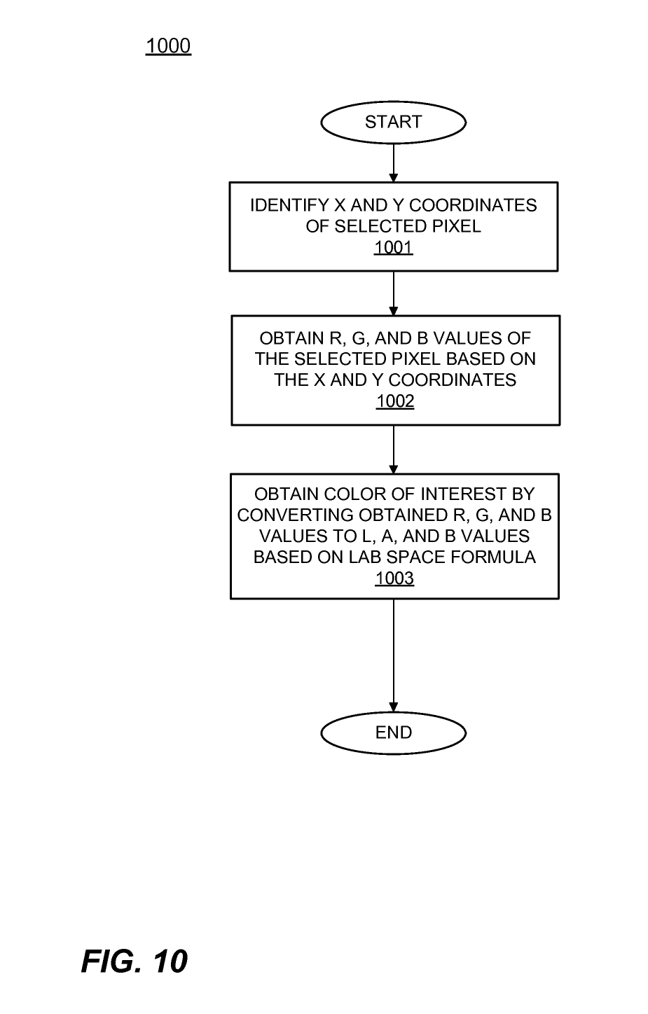

The determination module 304 determines a color of interest from the one pixel that was selected by the user by way of the pixel selection module 303. In one example, the determination module 304 invokes an application programming interface (API) that reads, for example, from a video driver, a mathematical representation (e.g., numerical values for the red green, and blue color components) of the color associated with the selected pixel, based on coordinates (e.g., X and Y coordinates) of the pixel. The determination module 304, in accordance with another example aspect herein, implements a procedure 1000 for determining a color of interest from a selected pixel, as described in further detail below in connection with FIG. 10.

In another example aspect herein, the color adjusting module 305 enables the user to manually adjust the color of interest determined by the determination module 304, by using one or more adjustable user interface elements (e.g., three independently movable user interface sliders for the red, green, and blue color components, respectively). In this way, the user may fine-tune the color of interest before the color of interest is used as the basis for identifying any product recommendations.

In one example embodiment, in lieu of an image being selected by way of the image selection module 302, a pixel being selected by way of the pixel selection module 303, and a color of interest being determined by the determination module 304 (as discussed above), the color adjusting module 305 enables the user to manually select a color of interest by using the one or more adjustable user interface elements. In this way, if the user has interest in a particular color, but lacks any image that includes that particular color, the user can still select that color for use in identifying product recommendations.

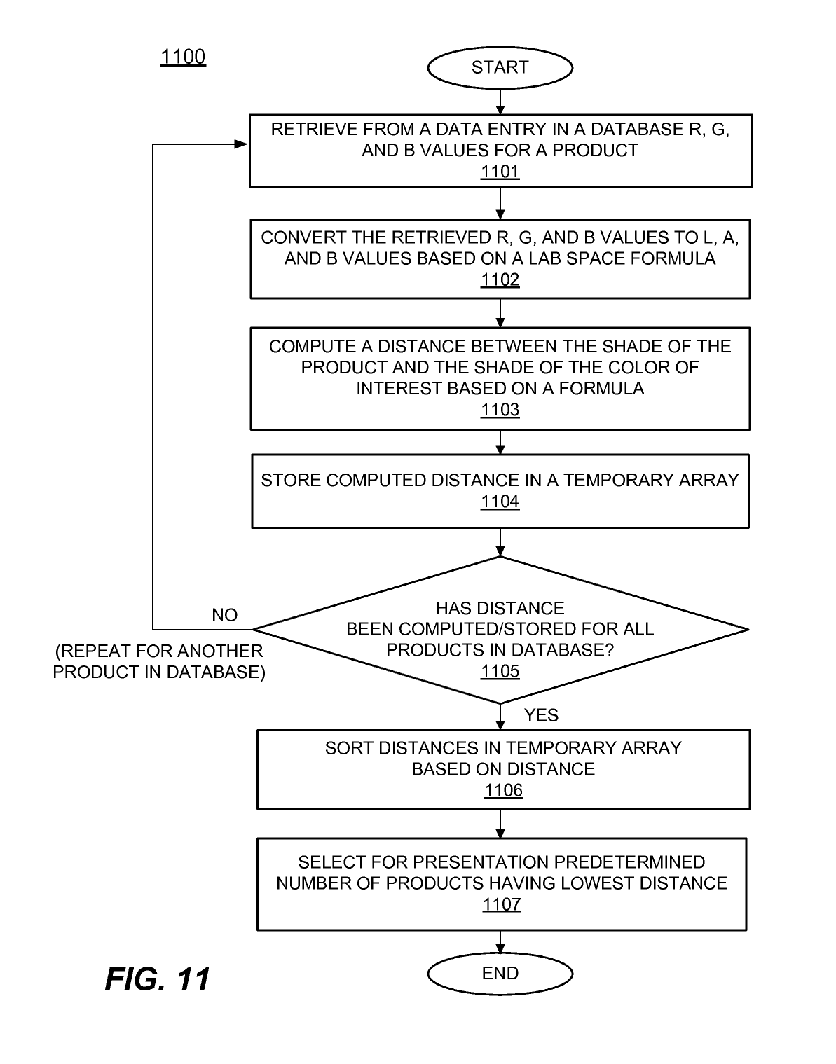

The identification module 306 identifies one or more products from a predetermined list of products based on the color of interest determined by the determination module 304 (and/or adjusted or selected by way of the color adjusting module 305, if applicable). In accordance with one example aspect herein, the identification module 306 implements a procedure 1100 for identifying, from a predetermined list of products, one or more product(s) for recommendation based on a color of interest, as described in further detail below in connection with FIG. 11. In one example, the identification module 306 implements one or more algorithms to match a mathematical representation (e.g., numerical values for the red green, and blue color components) of the color of the selected pixel (e.g., as determined by the determination module 304) to one or more mathematical representations of colors corresponding to products in the predetermined list of products stored in the database 103. In this way, the identification module 306 may identify in the predetermined list of products, based on a predetermined mathematical color model (e.g., a Color Lab Space formula, as is known in the art), one or more products that have colors or shades that are similar, or complementary, to the color of interest determined by the determination module 304.

The presentation module 307 presents to the user, via a user interface, one or more identifiers corresponding to the one or more products, respectively, identified by the identification module 306. In one example, the presentation module 307 displays a plurality of identifiers of the products and/or other related product information (e.g., (1) a corresponding product identifier, (2) a category to which the product belongs, (3) one or more images showing one or more colors of the product, (4) a name of the product, (5) a name of a color of the product, (6) a pre-stored image of the product and/or product packaging, and/or the like) corresponding to the plurality of products (e.g., cosmetics products), respectively, identified by the identification module 306.

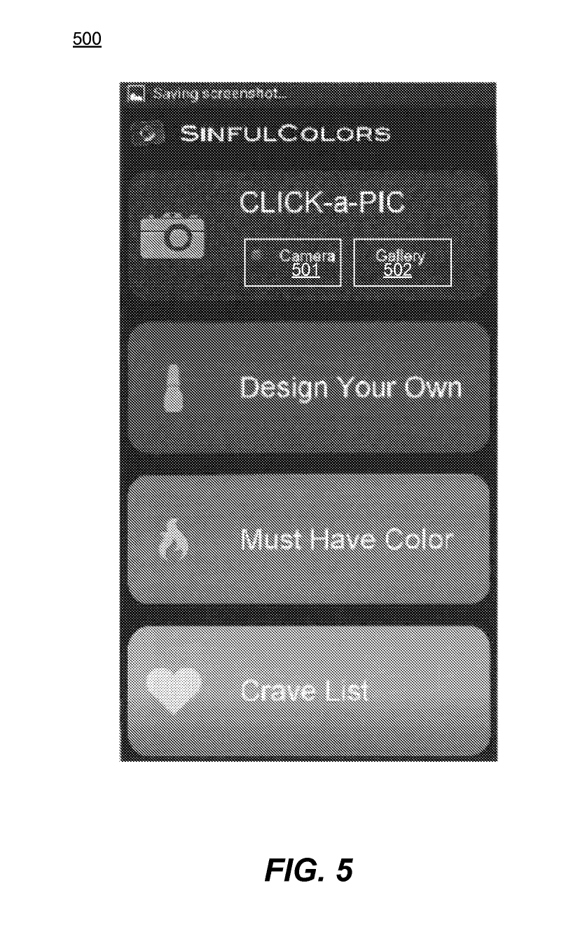

Having described exemplary functional modules that may be included in a memory device 301 used for providing a product recommendation based on a color, reference will now be made to FIG. 4, which shows a flowchart illustrating an example procedure 400 for providing a product recommendation based on a color. Reference will also be made to FIGS. 5 through 9, which illustrate example interfaces that may be employed in accordance with the procedure 400, in accordance with various example embodiments herein.

At block 401, the user is enabled to select an image from a plurality of preselected images (e.g., images pre-stored on the user device 101, the server 102, and/or the database 103). In another example, the user is enabled to select the image from a photographic image captured via a camera, such as a camera (e.g., the camera 105) resident on a mobile device (e.g., the user device 101). The image may be an image of an object, a photographic image, and/or another type of image.

In one example embodiment, an example interface 500, shown in FIG. 5, is presented to the user to enable the user to initiate the selection of an image. The interface 500 includes a camera button 501 and a gallery button 502. The camera button 501 is selectable by the user to enable the user to select the image from a photographic image captured via a camera, such as a camera (e.g., the camera 105) resident on a mobile device (e.g., the user device 101). The gallery button 502 is selectable by the user to select an image from a plurality of preselected images (e.g., an image gallery).

At block 402, the user is enabled to select a pixel from a plurality of pixels of the image selected at block 401. In one example, the image is presented via a display, and the user is enabled to select the pixel of the image by pointing to the pixel with a cursor or pointing device, such as a mouse, or with a finger or stylus on a touchscreen display.

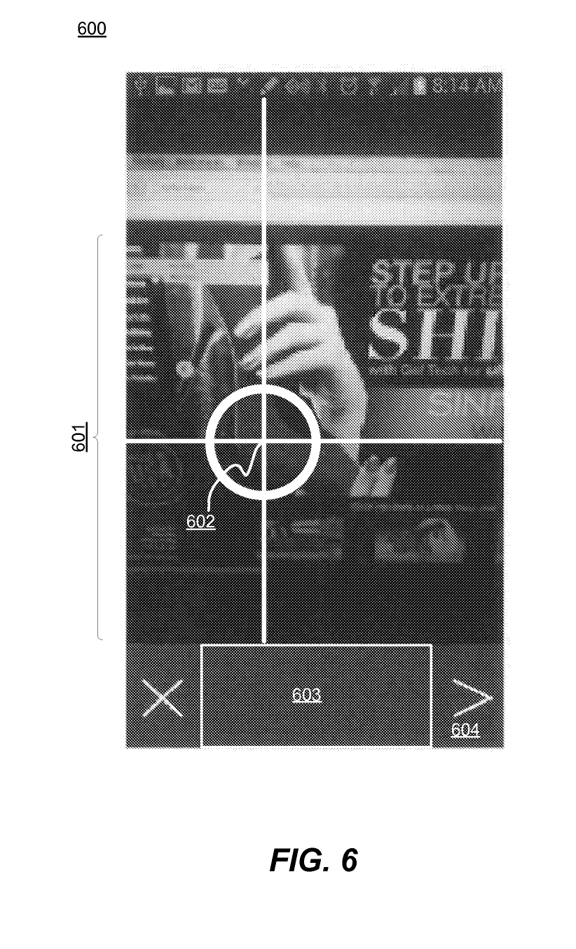

In one example embodiment, an example interface 600, shown in FIG. 6, is presented to the user to enable the user to select a pixel from a plurality of pixels of the image selected at block 401. The interface 600 includes an image portion 601, in which the image is presented to the user. The interface 600 also includes an interactive pixel cursor (e.g., including a circular portion and two lines bisecting the circular portion) that may be dragged over the image by the user and placed over the pixel of interest. In another example aspect herein, the color of the pixel over which the pixel cursor is placed is also presented in a color viewing portion 603 of the interface 600 to provide a clear view of the color. Once the pixel cursor is placed over the pixel having the color in which the user is interested, the user may select a next button 604 to confirm the selection of the pixel.

At block 403, a color of interest is determined from the one pixel that was selected by the user at block 402. In one example, the color of interest (e.g., the color of the selected pixel) is determined from the selected pixel by invoking an API that reads, for example, from a video driver, a mathematical representation (e.g., numerical values for the red green, and blue color components) of the color of the selected pixel, based on coordinates (e.g., X and Y coordinates) of the pixel. An example procedure 1000 for determining a color of interest from a selected pixel is described in further detail below in connection with FIG. 10.

In another example aspect herein, at optional block 404, the user is enabled to manually adjust the color of interest determined at block 403, by using one or more sliding user interface elements (e.g., three independently adjustable user interface sliders for the red, green, and blue color components, respectively). In this way, the user may fine-tune the color of interest before the color of interest is used as the basis for identifying any product recommendations.

In one example embodiment, in lieu of selecting an image (block 401), selecting a pixel (block 402), and determining a color of interest (block 403), the user is enabled to manually select a color of interest by using the one or more adjustable user interface elements. In this way, if the user has interest in a particular color, but lacks any image that includes that particular color, the user can still select that color for use in identifying product recommendations.

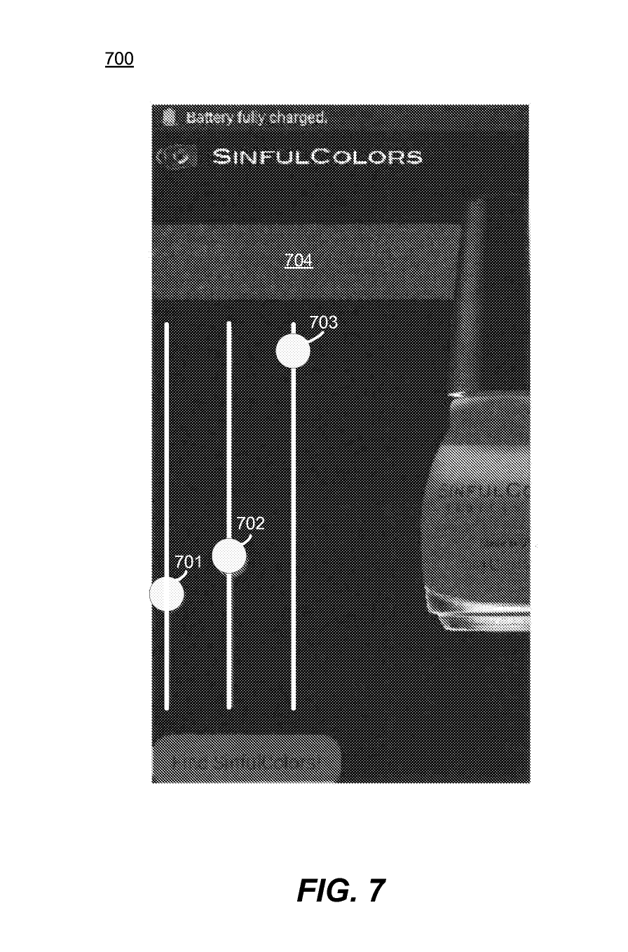

An example interface 700 for enabling the user to adjust the color of interest is shown in FIG. 7. The interface 700 includes a red sliding user interface element 701 (for adjusting the red color component of the color of interest), a green sliding user interface element 702 (for adjusting the green color component of the color of interest), a blue sliding user interface element 703 (for adjusting the blue color component of the color of interest), and a color viewing portion 704, in which a color of interest based on the positions of the three sliding user interface elements 701, 702, and 703 is presented to the user.

At block 405, one or more products are identified from a predetermined list of products stored in the database 103 based on the color of interest determined at block 403 (and/or adjusted or selected at block 404, if applicable). An example procedure 1100 for identifying, from a predetermined list of products, one or more product(s) for recommendation based on a color of interest, as described in further detail below in connection with FIG. 11. In one example, one or more algorithms are implemented to match a mathematical representation (e.g., numerical values for the red green, and blue color components) of the color of the selected pixel (e.g., as determined at block 403) to one or more mathematical representations of colors corresponding to products in the predetermined list of products stored in the database 103. In this way, based on a predetermined mathematical color model (e.g., a Color Lab Space formula, as is known in the art), one or more products in the predetermined list of products that have colors or shades that are similar, or complementary, to the color of interest determined at block 403 may be identified.

At block 406, the user is presented with, via a user interface, one or more identifiers corresponding to the one or more products, respectively, identified at block 405. In one example, the user is presented with a plurality of identifiers of the product and/or other product information (e.g., (1) a corresponding product identifier, (2) a category to which the product belongs, (3) one or more images showing one or more colors of the product, (4) a name of the product, (5) a name of a color of the product, (6) a pre-stored image of the product and/or product packaging, and/or the like) corresponding to the plurality of products (e.g., cosmetics products), respectively, identified at block 405.

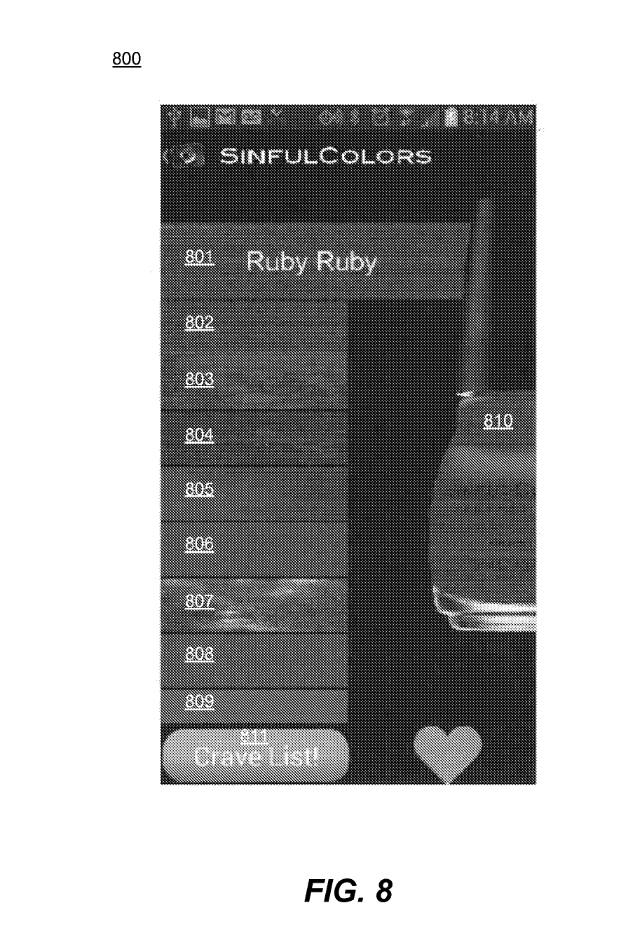

FIG. 8 shows an example interface 800 for presenting identifiers of recommended products, according to an example embodiment herein. The interface 800 includes an array of colors 801, 802, 803, 804, 805, 806, 807, 808, and 809 that each represent a color of a product identified at block 405. A name of the color 801 (i.e., “Ruby Red,” in the example of FIG. 8) is presented as an overlay upon the color 801. Also included in the interface 800 is a pre-stored image of a product (e.g., a nail polish container), that corresponds to one or more of the products associated with the colors 801, 802, 803, 804, 805, 806, 807, 808, and 809.

The interface 800 also includes a crave list button 811. The user may mark one or more of the colors 801, 802, 803, 804, 805, 806, 807, 808, and 809 and then may select the crave list button 811 to cause the identifiers of the products corresponding to the marked color(s) to be stored, at optional block 407, for future reference.

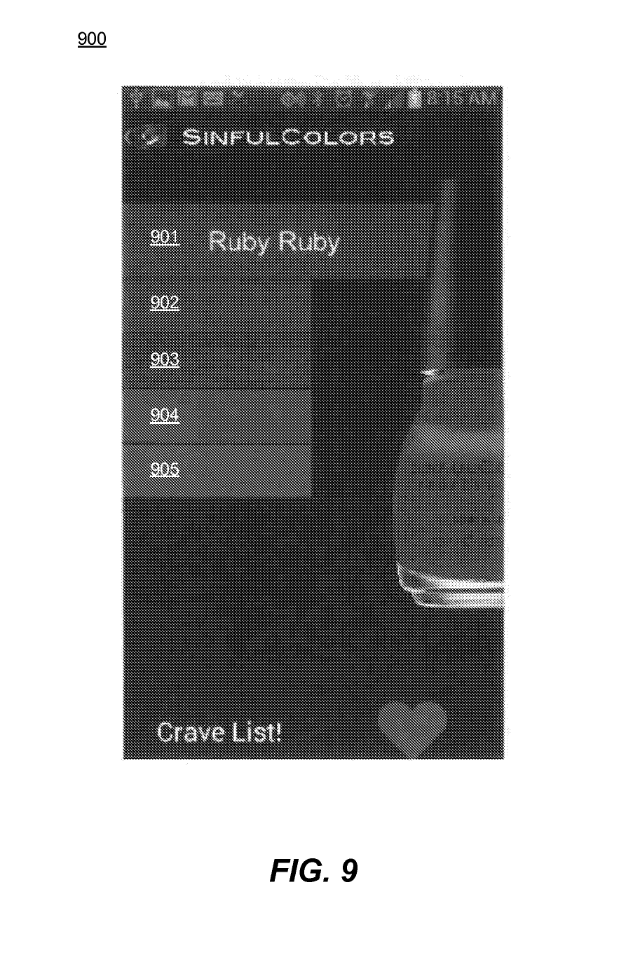

FIG. 9 shows an example interface for storing identifiers of recommended products for future reference, according to an example embodiment herein. The interface 900 shows an example crave list, which includes example colors 901, 902, 903, 904, 905 (which, in one example may correspond to certain ones of the colors 801, 802, 803, 804, 805, 806, 807, 808, and 809 shown in FIG. 8) that the user has selected for to be stored, at optional block 407, for future reference. The identifiers of the products may be stored on the user device 101, on the server 102, and/or on the database 103, as a favorites list for the particular user. The user may refer to the list, e.g., when the user travels to a retailer to browse and/or purchase the products.

Having described an example procedure 400 for providing a product recommendation based on a color, reference will now be made to FIG. 10 to describe an example procedure 1000 for determining a color of interest from a selected pixel, in accordance with example aspects herein. In some example aspects herein, the procedure 1000 may represent further functionality that may be implemented by the determination module 304 of FIG. 3, and/or in connection with block 403 of FIG. 4, described above.

At block 1001, coordinates (e.g., X and Y coordinates) for a pixel that has been selected by a user (e.g., as described above in connection with block 402 of FIG. 4) are determined. In one example, an API (e.g., a commercially available API) is invoked to return the X and Y coordinates of the pixel selected by the user. In one example embodiment, the X and Y coordinates for the selected pixel are obtained as follows by invoking features of the commercially available Android® API:
View.OnTouchListener.onTouch(View v, MotionEvent motionEvent)
x=motionEvent.getX( )
y=motionEvent.getY( )

At block 1002, R, G, and B values of the selected pixel are obtained based on the X and Y coordinates identified at block 1001. In one example, an API (e.g., a commercially available API, such as the API “android.graphics.Bitmap.getPixel( )”) is invoked to return the R, G, and B values of the pixel that has been selected by the user.

In one example embodiment, at block 1003, the R, G, and B values of the pixel that were obtained at block 1002 are converted to L, a, and b values by using a Color Lab Space formula, as is known in the art. The L, a, and b values determined for the pixel at block 1003 are a numerical representation of the color of interest, which as described above in connection with FIG. 4, can be utilized as the basis for identifying and presenting one or more product recommendations.

Reference will now be made to FIG. 11 to describe an example procedure 1100 for identifying, from a predetermined list of products, one or more product(s) for recommendation based on a color of interest. In some example aspects herein, the procedure 1100 may represent further functionality that may be implemented by the identification module 306 of FIG. 3, and/or in connection with block 405 of FIG. 4, described above.

At block 1101, R, G, and B values for a product (e.g., a first product in a list of products) are retrieved from a data entry corresponding to the product, the data entry being stored in a database (e.g., the database 103).

At block 1102, the R, G, and B values retrieved for the product at block 1101 are converted to L, a, and b values by using a Color Lab Space formula, as is known in the art. The L, a, and b values of the product are a numerical representation of the shade of the product. In one example embodiment, instead of converting R, G, and B values to L, a, and b values at block 1102, the R, G, and B values of each product having a data entry in a database (e.g., the database 103) may be pre-converted to L, a, and b values (e.g., prior to implementation of the procedure 1000) and stored in the database.

At block 1103, a distance (d) between the shade of the product and the shade of a color of interest (e.g., a color of interest determined by the determination module 304 of FIG. 3, and/or in connection with block 403 of FIG. 4 and/or procedure 1000 of FIG. 10) is computed based on a formula, such as the following formula:

d=\sqrt{(L₂−L₁)²+(a₂−a₁)₂+(b₂−b₁)²}

where:

L₂, a₂, and b₂ represent the L, a, and b values, respectively, of the shade of the product; and

L₁, a₁, and b₁ represent the L, a, and b values, respectively, of the shade of the color of interest.

In one example aspect herein, the distance (d) is inversely proportional to a degree of similarity between the shade of the product and the shade of the color of interest. That is, the lower that the distance between the two shades is, the more similar the two shades are. As persons of skill in the art would appreciate, R, G, B values may be utilized in the above formula in place of the L, a, and b values, respectively; in which case, the conversion from R, G, and B values to L, a, and b values (e.g., as discussed in connection with block 1003 of FIG. 10 and block 1102 of FIG. 11) need not be performed.

At block 1104, the distance computed at block 1103 is stored in a temporary array.

At block 1105, a determination is made as to whether a distance between the shade of a product in the database and the shade of the color of interest has been computed for all of the products stored in the database. If it is determined at block 1105 that a distance between the shade of a product in the database and the shade of the color of interest has not been computed for all of the products stored in the database (“NO” at block 1105), then control returns to block 1101, to compute the distance for another of the products stored in the database. If, on the other hand, it is determined at block 1105 that a distance between the shade of a product in the database and the shade of the color of interest has been computed for all of the products stored in the database (“YES” at block 1105), then the procedure continues to block 1106.

At block 1106, all of the distances stored in the temporary array are sorted (i.e., rearranged) based on distance. For example, the distances can be sorted in an order of increasing distance or can be sorted in an order of decreasing distance. In one example, embodiment, instead of sorting the distances in the temporary array, the distances in the temporary array are assigned indices indicating their values relative to each other (e.g., a lowest of the distances can be assigned an index of 1, a next lowest of the distances can be assigned an index of 2, and so on).

At block 1107, a predetermined number (e.g., 10) of products having the lowest distances (representing the closest matches) are selected for presentation (e.g., as described above in connection with the presentation module 307 of FIG. 3, and/or in connection with block 406 of FIG. 4, described above.) to the user as recommended products.

As can be appreciated in view of the above, the example embodiments described herein provide systems, methods, and computer program products for providing a product recommendation based on a color, such as a color that is provided and/or selected by a user, thereby making the task of choosing a product more manageable. In one example, the example embodiments described herein enable a user to identify certain products of interest, such as, for example, cosmetics, based on a color the user has found to be appealing, for example, in an object or a magazine photograph that the user has encountered. The user is enabled to identify, and/or receive recommendations of, cosmetics having a similar color. The user is also enabled to obtain and browse the recommendations via a convenient and user-friendly interface.

While various example embodiments have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the general public, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for providing a product recommendation based on color, the system comprising:
a computer processor; and
a memory device accessible by the computer processor and storing at least one of:
computer code executable by the computer processor, and
data used by the computer code,
wherein the computer code includes:
a determination module that determines a color of interest from one pixel,
an identification module that identifies a product from a predetermined list of products based on the color of interest, and
a presentation module that presents an identifier of the product via a user interface.

2. The system of claim 1, wherein the computer code further includes:
a pixel selection module that enables a user to select the pixel from an image having a plurality of pixels,
an image selection module that enables a user to select the image from:
a plurality of preselected images, or
a photographic image captured via a camera resident on a mobile device.

3. The system of claim 2, wherein the image is an image of an object.

4. The system of claim 2, wherein the image is a photographic image.

5. The system of claim 1, wherein the identification module identifies the product by identifying, based on a predetermined mathematical color model, the product in the predetermined list of products that has a color that is most similar to the color of interest.

6. The system of claim 1, wherein the identification module identifies the product by identifying, based on a predetermined mathematical color model, the product in the predetermined list of products that has a color that is complementary to the color of interest.

7. The system of claim 1, wherein the identifier of the product includes any one or a combination of:
a name of the product,
a name of a color of the product, and
a pre-stored image of the product.

8. A method for providing a product recommendation based on color, the method comprising steps of:
determining a color of interest from one pixel of a digital image;
using a computer processor to identify a product from a predetermined list of products based on the color of interest; and
displaying an identifier of the product via a user interface of a display device.

9. The method of claim 8, further comprising steps of
enabling a user to select the pixel from an image having a plurality of pixels; and
enabling the user to select the image from:
a plurality of preselected images, or
a photographic image captured via a camera resident on a mobile device.

10. The method of claim 9, wherein the image is an image of an object.

11. The method of claim 9, wherein the image is a photographic image.

12. The method of claim 8, wherein the identifying the product includes identifying, based on a predetermined mathematical color model, the product in the predetermined list of products that has a color that is most similar to the color of interest.

13. The method of claim 8, wherein the identifying the product includes identifying, based on a predetermined mathematical color model, the product in the predetermined list of products that has a color that is complementary to the color of interest.

14. The method of claim 8, wherein the identifier of the product includes any one or a combination of:
a name of the product,
a name of a color of the product, and
a pre-stored image of the product.

15. A computer-readable storage medium storing an application, resident on a mobile device, for providing a product recommendation based on color, the application comprising:
computer code executable by a computer processor,
wherein the computer code includes:
a determination module that determines a color of interest from one pixel,
an identification module that identifies a product from a predetermined list of products based on the color of interest, and
a presentation module that presents an identifier of the product via a user interface.

16. The computer-readable storage medium of claim 15, wherein the computer code further includes:
a pixel selection module that enables a user to select the pixel from an image having a plurality of pixels,
an image selection module that enables a user to select the image from:
a plurality of preselected images, or
a photographic image captured via a camera resident on a mobile device.

17. The computer-readable storage medium of claim 16, wherein the image is an image of an object.

18. The computer-readable storage medium of claim 16, wherein the image is a photographic image.

19. The computer-readable storage medium of claim 15, wherein the identification module identifies the product by identifying, based on a predetermined mathematical color model, the product in the predetermined list of products that has a color that is most similar to the color of interest.

20. The computer-readable storage medium of claim 15, wherein the identification module identifies the product by identifying, based on a predetermined mathematical color model, the product in the predetermined list of products that has a color that is complementary to the color of interest.

21. The computer-readable storage medium of claim 15, wherein the identifier of the product includes any one or a combination of:
a name of the product,
a name of a color of the product, and
a pre-stored image of the product.

22. A system for providing a product recommendation based on color, the system comprising:
a computer processor; and
a memory device accessible by the computer processor and storing at least one of:
computer code executable by the computer processor, and
data used by the computer code,
wherein the computer code includes:
a color input module that enables a user to input a color of interest via one or more sliding user interface elements;
an identification module that identifies a product from a predetermined list of products based on the color of interest, and
a presentation module that presents an identifier of the product via a user interface.

23. A method for providing a product recommendation based on color, the method comprising steps of:
enabling a user to input a color of interest via one or more sliding user interface elements manipulable via a user interface of a display device;
using a processor to identify a product from a predetermined list of products based on the color of interest, and
displaying an identifier of the product via the user interface.

24. A computer-readable storage medium storing an application, resident on a mobile device, for providing a product recommendation based on color, the application comprising:
computer code executable by a computer processor,
wherein the computer code includes:
a color input module that enables a user to input a color of interest via one or more sliding user interface elements;
an identification module that identifies a product from a predetermined list of products based on the color of interest, and
a presentation module that presents an identifier of the product via a user interface.
